(19) United States
(12) Patent Application Publication
(10) Pub. No.: US 2015/0027615 A1
(43) Pub. Date: Jan. 29, 2015

(54) METHODS OF MAKING MULTILAYER ENERGY STORAGE DEVICES

(71) Applicant: WILLIAM MARSH RICE UNIVERSITY, Houston, TX (US)

(72) Inventors: Neelam Singh, Houston, TX (US); Charudatta Galande, Houston, TX (US); Akshay Mathkar, Houston, TX (US); Leela M. Reedy Arava, Houston, TX (US); Pulickel M. Ajayan, Houston, TX (US); Alexandru Vlad, Court Saint Etienne (BE)

(73) Assignee: William Marsh Rice University, Houston, TX (US)

(21) Appl. No.: 14/385,283

(22) PCT Filed: Mar. 15, 2013
(86) PCT No.: PCT/US13/32394

§ 371 Date: Sep. 15, 2014

Related U.S. Application Data
(60) Provisional application No. 61/611,308, filed on Mar. 15, 2012.

(51) Int. Cl. H01M 10/0585; H01M 4/04; H01M 2/16; H01M 4/139; H01M 10/0525; H01M 4/131

(52) U.S. Cl. CPC H01M 10/0585; H01M 10/0525; H01M 4/131; H01M 2/1653; H01M 4/139; H01M 4/0419; H01M 2300/0037; H01M 10/0568
USPC 156/60; 427/58; 427/122; 427/123; 427/126.6; 427/126.3; 427/126.4; 427/126.1

(57) ABSTRACT

The present invention provides additive manufacturing methods of forming multilayer energy storage devices on a surface by formulating all components of the multilayer energy storage device into liquid compositions and: (1) applying a first liquid current collector composition above the surface to form a first current collector layer above the surface; (2) applying a first liquid electrode composition above the first current collector layer to form a first electrode layer above the first current collector layer; (3) applying a liquid electrically insulating composition above the first electrode layer to form an electrically insulating layer above the first electrode layer; (4) applying a second liquid electrode composition above the electrically insulating layer to form a second electrode layer above the electrically insulating layer; and (5) applying a second liquid current collector composition above the second electrode layer to form a second current collector layer above the second electrode layer.

### CROSS-REFERENCE TO RELATED APPLICATIONS

This application claims priority to U.S. Provisional Patent Application No. 61/611,308, filed on Mar. 15, 2012. The entirety of the aforementioned application is incorporated herein by reference.

### STATEMENT REGARDING FEDERALLY SPONSORED RESEARCH

This invention was made with Government Support under Grant No. W911NF-10-2-0032, awarded by the U.S. Department of Defense. The Government has certain rights in the invention.

### FIELD OF INVENTION

The field of the present invention is related to the fabrication of multilayer energy storage devices, and in particular, for example, batteries, supercapacitors and capacitors of various shapes and sizes, and their integration with substrates (flat or curved) of various materials, such as metals, glass, ceramics and plastics.

### BACKGROUND

Current multilayer energy storage devices (such as batteries) suffer from various limitations, including bulkiness and inflexibility. Furthermore, current methods of making such multilayer energy storage devices can be expensive, hazardous, inefficient, and non-scalable. Therefore, a need exists for novel methods of making more flexible and compact multilayer energy storage devices in a more efficient, scalable and costly manner. The present disclosure addresses this need.

### SUMMARY

In some embodiments, the present disclosure provides methods of forming multilayer energy storage devices on a surface by: (1) applying a first non-solid current collector composition above the surface to form a first current collector layer above the surface; (2) applying a first non-solid electrode composition above the first current collector layer to form a first electrode layer above the first current collector layer; (3) applying a non-solid electrically insulating composition above the first electrode layer to form an electrically insulating layer above the first electrode layer; (4) applying a second non-solid electrode composition above the electrically insulating layer to form a second electrode layer above the electrically insulating layer; and (5) applying a second non-solid current collector composition above the second electrode layer to form a second current collector layer above the second electrode layer. In some embodiments, the first non-solid current collector composition is an anode current collector composition that forms an anode current collector layer, the first non-solid electrode composition is an anode electrode composition that forms an anode electrode layer, the second non-solid electrode composition is a cathode electrode composition that forms a cathode electrode layer, and the second non-solid current collector composition is a cathode current collector composition that forms a cathode current collector layer. In other embodiments, the first non-solid current collector composition is a cathode current collector composition that forms a cathode current collector layer, the first non-solid electrode composition is a cathode electrode composition that forms a cathode electrode layer, the second non-solid electrode composition is an anode electrode composition that forms an anode electrode layer, and the second non-solid current collector composition is an anode current collector composition that forms an anode current collector layer.

In some embodiments, each of the aforementioned compositions may include liquid formulations, such as paint. In some embodiments, one or more of the aforementioned compositions may be applied above a surface or another layer multiple times to form a plurality of layers above the surface or the other layer. In some embodiments, the compositions that are applied multiple times may be the same compositions. In some embodiments, the compositions that are applied multiple times may include one or more different compositions.

For instance, in some embodiments, the same non-solid electrically insulating compositions may be applied above the first electrode layer multiple times to form a plurality of the same electrically insulating layers above the first electrode layer. In other embodiments, one or more different non-solid electrically insulating compositions may be applied above the first electrode layer multiple times to form a plurality of one or more different non-solid electrically insulating layers above the first electrode layer.

In some embodiments, one or more of the aforementioned applying steps may include, without limitation, spraying, brushing, rolling, printing, and combinations thereof. In some embodiments, each of the aforementioned applying steps includes spraying.

In some embodiments, the surface on which multilayer energy storage devices form may include, without limitation, glass, fabrics, metals, plastics, ceramics, and combinations thereof. In some embodiments, the surface may serve as the first current collector layer. In some embodiments, another surface or solid composition may serve as a second current collector layer. The methods of the present disclosure can be used to make numerous multilayer energy storage devices. Exemplary multilayer energy storage devices include, without limitation, capacitors, supercapacitors, batteries, hybrids thereof, and combinations thereof.

### BRIEF DESCRIPTION OF THE FIGURES

FIG. 1 provides exemplary schemes of methods of making multilayer energy storage devices. FIG. 1A provides a scheme where all the individual layers are sprayed above surface 10 to form multilayer energy storage device 42 on surface 10. FIG. 1B provides a scheme where surface 50 serves as a first current collector layer, and the remaining layers are sprayed above surface 50 to form multilayer energy storage device 82 on surface 50. FIG. 1C provides a scheme where surface 100 serves as a first current collector layer, surface 124 serves as a second current collector layer, and the remaining layers are sprayed between the surfaces to form multilayer energy storage device 132 on surface 100. FIG. 1D provides a visual comparison of conventional multi-layer energy storage device 220 with multi-layer energy storage device 320, which was formed in accordance with the methods of the present disclosure.

FIG. 2 provides schemes and diagrams relating to methods of making paintable batteries. FIG. 2A is a simplified view of a conventional Li-ion battery, a multilayer device assembled as a tightly wound jellyroll′, sandwich of an anode, a separator, and a cathode layer. FIG. 2B provides a scheme for the direct fabrication of Li-ion batteries on a surface of interest by sequentially spraying component paints onto stencil masks that are tailored to desired geometries and surfaces. FIG. 2C provides an illustration of multilayer energy storage device 198 formed in accordance with the method illustrated in FIG. 2B.

FIG. 3 provides data relating to the electrochemical characterization of exemplary individual components of spray-painted Li-ion batteries. FIGS. 3A-3D show data relating to composite electrode charge-discharge curves and specific capacity vs. cycle numbers for spray painted LCO/polymer/Li half-cell cycled between 4.2-3V (FIGS. 3A-B) vs. Li/Li⁺ at C/8 (FIG. 3C), and LTO/polymer/Li half-cell cycled between 2-1V vs. Li/Li⁺ at C/5, measured after soaking the separator in electrolyte (1M LiPF₆ in 1:1 (v/v) EC:DMC) (FIG. 3D). Both half cells show desired plateau potentials and good capacity retention. FIGS. 3E-3G show data relating to polymer separator optimization. FIG. 3E shows that addition of DMF to polymer paint gave a mechanically robust separator but reduced ionic conductivity. FIG. 3F shows that addition of SiO₂ (at ˜11% DMF) helped recover the ionic conductivity while maintaining mechanical robustness. FIG. 3G shows an electrochemical impedance spectrum (EIS) at high frequency of a typical polymer separator with an ionic conductivity of about 1.24×10⁻³ S/cm. Ionic conductivities were calculated from recorded EIS spectra in the 100 KHz-1 Hz range at 0.01V AC bias.

FIG. 4 provides data relating to the characterization of an exemplary spray painted Li-ion cells. FIG. 4A (left panel) shows an image of a glazed ceramic tile with an exemplary spray painted Li-ion cell (area 5×5 cm², capacity ˜30 mAh) before packaging and a similar cell packaged with laminated aluminum foil after electrolyte addition and heat sealing inside a glove box (right panel). FIG. 4B shows a cross-sectional SEM micrograph of the exemplary spray painted Li-ion full cell showing its multilayered structure, with interfaces between successive layers indicated by dashed lines for clarity (Scale bar is 100 μm). FIGS. 4C-D show charge-discharge curves for 1^{st}, 2^{nd} 20^{th} and 30^{th} cycles (FIG. 4C) and specific capacity vs. cycle numbers (FIG. 4D) for the spray painted full cell (LCO/Kynarflex-PMMA-SiO₂/LTO) cycled at a rate of C/8 between 2.7-1.5 V.

FIG. 5 shows various images relating to paintable batteries. FIGS. 5A-C show Li-ion cells fabricated on glass slide (FIG. 5A); stainless steel sheet (FIG. 5B); and glazed ceramic tile (FIG. 5C). FIG. 5D shows a fully charged battery of 9 parallel-connected cells powering 40 red LEDs that spell ‘RICE’. FIG. 5E shows a flexible spray-painted Li-ion cell fabricated on a PET transparency sheet, powering LEDs. FIG. 5F shows a spray painted Li-ion cell fabricated on the curved surface of a ceramic mug, powering LEDs. The electrodes were sprayed through a stencil mask to spell ‘RICE’. The cell areas in FIGS. 5A-F have been highlighted by dashed lines for clarity.

FIG. 6 depicts exemplary formulations for various components of the paintable batteries.

FIG. 7 shows images relating to the effect of DMF content in paint on separator morphology. The images are cross sectional SEM micrographs of spray painted polymer separators fabricated from: pure Kynarflex in acetone showing highly porous layered film (FIG. 7A); pure Kynarflex in DMF with almost no porosity (FIG. 7B); 3:1 Kynarflex:PMMA in acetone having layered structure with more porosity than FIG. 7B (FIG. 7C); 3:1 Kynarflex:PMMA in 1:8 DMF:acetone with lesser porosity than FIG. 7C (FIG. 7D); and 3:1 Kynarflex:PMMA in 1:4 DMF:acetone with even lower porosity than FIG. 7D (FIG. 7E).

FIG. 8 shows images relating to the effect of SiO₂ content on separator porosity. The images are cross sectional SEM micrographs of fractured spray painted polymer separators fabricated from 3:1 Kynarflex:PMMA in 1:8 DMF:Acetone doped with no SiO₂ (FIG. 8A); 10% SiO₂ (FIG. 8B); and 20% SiO₂ (FIG. 8C). Polymer film containing no SiO₂ had the lowest porosity.

FIG. 9 provides EIS spectra of spray painted separators. FIG. 9A provides a comparison of EIS spectra of Kynarflex:PMMA separators painted with varying DMF:acetone ratios up to 1:4. FIG. 9B provides a comparison of EIS spectra of separators with varying SiO₂ content up to 20 wt. %. Two Stainless steel electrodes were used as blocking electrodes for recording EIS spectra in the 100 KHz-1 Hz frequency range.

FIG. 10 provides images relating to the multilayer fabrication of paintable batteries, including an untreated glazed ceramic tile (FIG. 10A); an SWNT current collector layer painted on the tile (FIG. 10B); an LCO cathode painted onto the SWNT current collector layer (+ve electrode) (FIG. 10C); a Kynarflex-PMMA porous polymer separator layer painted onto the LCO electrode (FIG. 10D); an LTO anode layer (−ve electrode) painted onto the polymer separator layer as a replica of the LCO electrode (FIG. 10E); and a copper current collector layer painted onto the anode layer (FIG. 10F).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Multilayer energy storage devices such as batteries, supercapacitors and capacitors (and in particular batteries, such as, for example Li-ion batteries) are composed of five basic layers: the cathode current collector, the cathode, the separator, the anode and the anode current collector. In conventional battery manufacturing processes (and in particular manufacturing processes pertaining to Li-ion batteries), the various component layers are fabricated separately and then assembled in a separate step.

The cathode and anode layers are typically fabricated by coating a liquid dispersion consisting of the electrode active materials, electrically conducting additives and polymeric binders and one more solvents, onto appropriate metallic current collector foils in a roll-to-roll process. The processes typically used for coating the above mentioned liquid dispersions onto the metallic current collector foils are extrusion, reverse roll coating, knife over roll coating, doctor blade methods, slot die coating, or variations of these processes. The polymeric separator films are typically produced from polymer materials by drawing (dry process) or phase separation (wet process) processes. Typically, dry processes involve melting of one or more polymer materials, extruding them into thin films, thermal annealing the polymer films, and stretching the polymer films precisely to form micropores within the film. Wet processes typically involve mixing the polymer with a low molecular weight substance, melting the mixture, and extruding the melt into a sheet. Wet processes may also involve extraction of low molecular weight substances with a volatile solvent to form micropores within the film. The individually fabricated cathode, anode and separator layers are then assembled into a cell in a further assembly step.

The components manufactured by roll-to-roll processes described above are cut into required sizes and assembled into a cell by winding or stacking individual component layers. During the assembly process, steps involving precise cutting of the component layers (also known as tailoring), and alignment of the component layers (i.e., to form a sandwich of cathode, separator and anode) are critical steps. Poorly cut components may result in electrical shorts between electrodes, which could in turn constitute economic losses and safety hazards. In addition, misaligned components can cause poor cell performance and faster degradation of electrochemical performance. Therefore, a process in which the fabrication of individual components and their assembly into a cell can be achieved in the same step would be more efficient due to elimination of the tailoring step and the assembly of separately produced components.

To produce a compact cell, the sandwich structure described above is tightly wound into a jellyroll′ type of configuration by wrapping the sandwich over a polymeric winding core. Depending on the type of winding core, the cell formed may assume one of two shapes: cylindrical shapes in the case of cylindrical cores, and cuboid shapes (also known as prismatic shapes) in case of flat cores.

As described above, the cells produced by the conventional roll-to-roll fabrication process are limited in form factor to cylindrical and prismatic shapes. Therefore, the cells typically need a specifically shaped compartment when used for various applications, such as use in electronic devices. This limitation on the form factor of energy storage devices limits the possibilities of their integration into applications. The limitation also constrains the form factors in which the end application (in particular electronic devices) can be designed and produced. For example, a prismatic cell with right-angled corners when fitted into a space with curved edges (such as in a mobile phone) cannot utilize all available space for energy storage.

Therefore, a process is desired which can produce energy storage devices of any shape and size, and with any required foot-print, that would be able to utilize all available space in end applications. This would in turn increase the amount of stored energy that can be integrated with the devices, thereby enhancing the durability (e.g., battery life) of such applications.

Furthermore, the energy storage devices produced using the above mentioned roll-to-roll processes tend to be mechanically rigid. This also limits the possibilities of their integration with applications that may need energy storage devices to be mechanically flexible. A scalable fabrication process that could produce mechanically flexible energy storage devices would be beneficial for design of applications which could exploit this property.

The amount of energy that can be packed into a given cell volume, also called the energy density, is dependent on the thickness of the electrode layers. Thicker electrode layers enable a higher proportion of electrochemically active mass and volume as compared to inactive mass and volume, such as current collectors, winding cores and packaging. In turn, the thickness can increase the energy density. In the conventional roll-to-roll manufacturing processes described above, liquid dispersions cast onto the current collector foils require long drying times and are prone to cracking, which limits the thicknesses of electrode layers achievable using these processes. Thus, a process that enables thicker electrode layers can greatly enhance the achievable energy density of the energy storage device.

Although Li-ion batteries have a high energy density as compared to other battery types, their comparatively high cost has been a barrier in their adoption in applications such as electric vehicles, hybrid electric vehicles and plug-in hybrid electric vehicles. A simpler, more cost effective manufacturing process with fewer manufacturing steps could reduce the cost of batteries, enabling wider adoption into such applications.

In various embodiments, the present disclosure addresses the aforementioned needs and limitations by providing various methods of forming multilayer energy storage devices on various surfaces. In some embodiments, such methods include: (1) applying a first non-solid current collector composition above the surface to form a first current collector layer above the surface; (2) applying a first non-solid electrode composition above the first current collector layer to form a first electrode layer above the first current collector layer; (3) applying a non-solid electrically insulating composition above the first electrode layer to form an electrically insulating layer above the first electrode layer; (4) applying a second non-solid electrode composition above the electrically insulating layer to form a second electrode layer above the electrically insulating layer; and (5) applying a second non-solid current collector composition above the second electrode layer to form a second current collector layer above the second electrode layer. In further embodiments, the methods of the present disclosure may also include a step of activating the formed multilayer energy storage devices, such as by adding one or more electrolytes to the formed device. In some embodiments, the surface may be heated before an application step. In some embodiments, the surface may be heated to temperatures that range from about 50° C. to about 150° C. In some embodiments, the non-solid compositions may be liquid compositions.

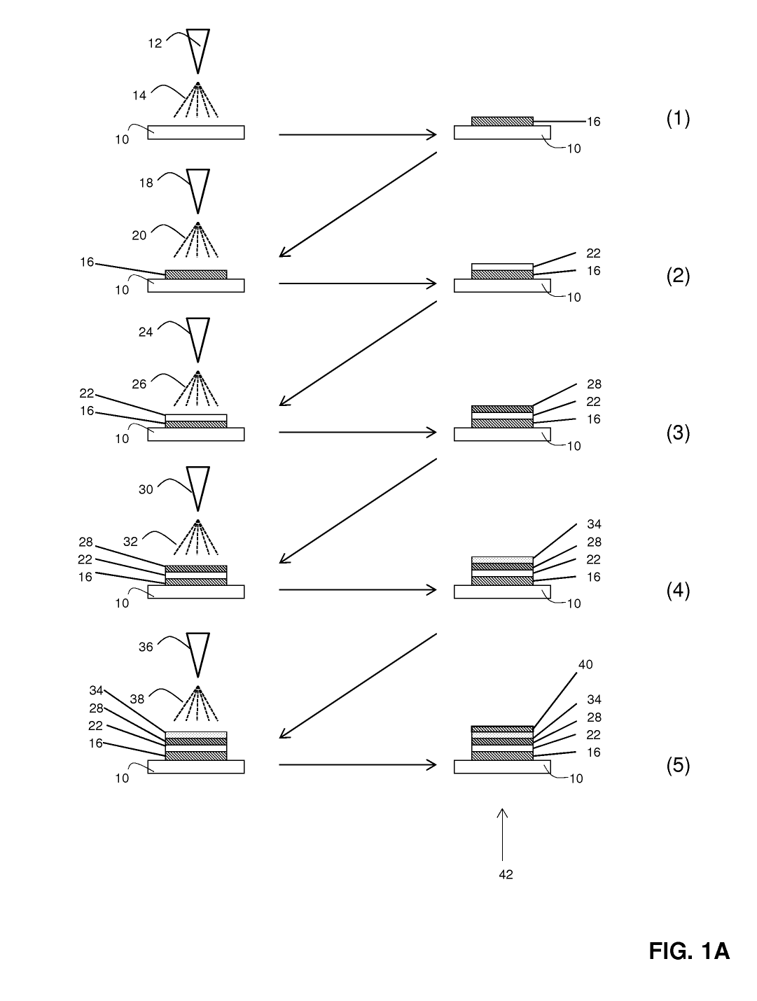

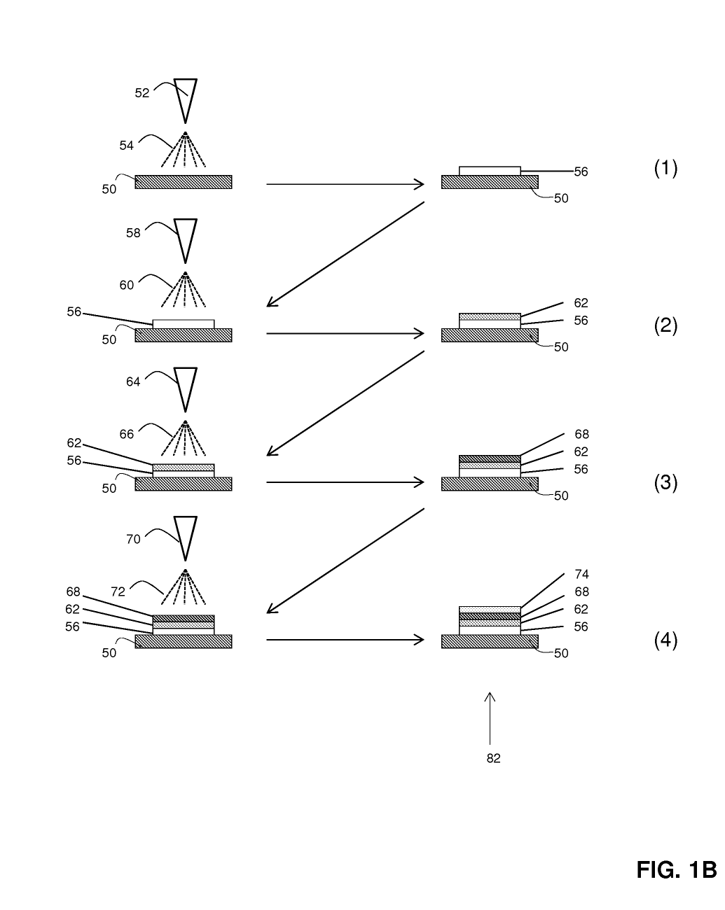

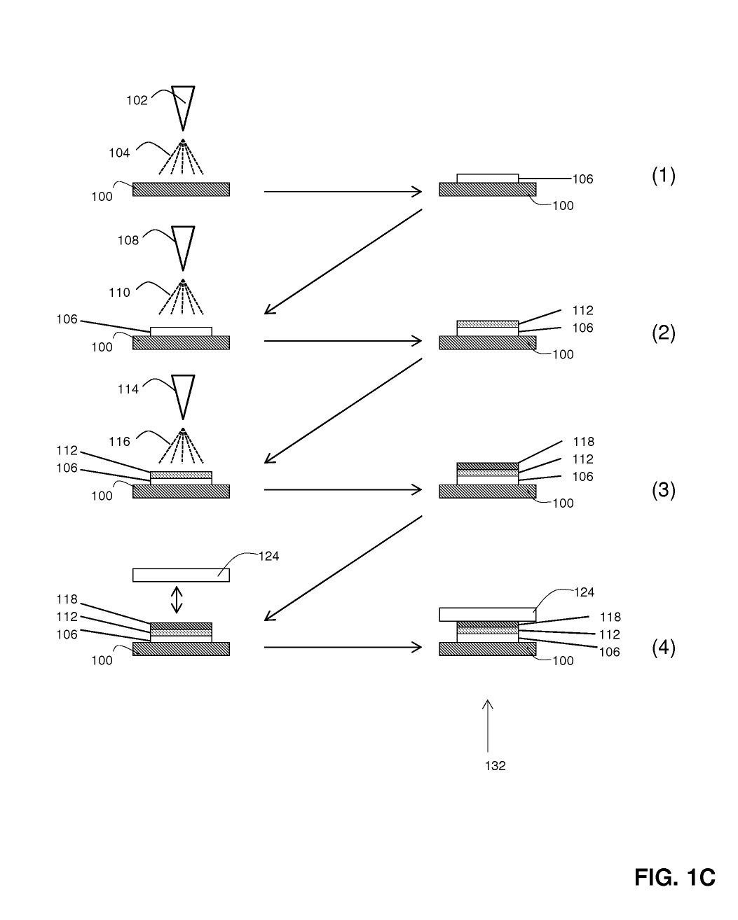

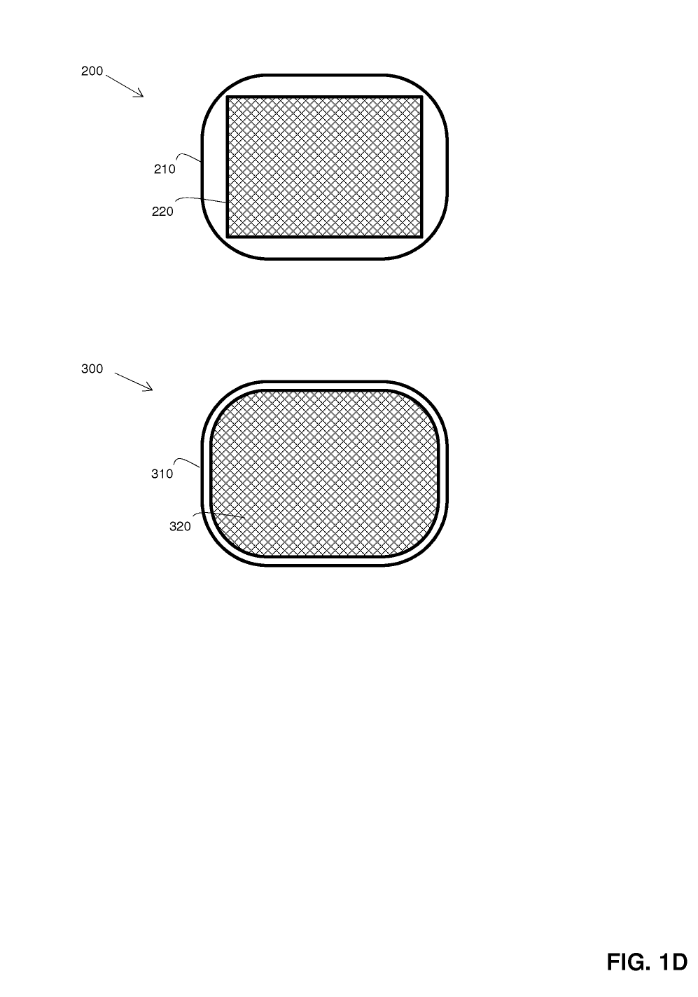

A more specific embodiment of the aforementioned method is shown in FIG. 1A. In this embodiment, multilayer energy storage device 42 is formed on surface 10 by: (1) spraying first liquid current collector composition 14 from container 12 above surface 10 to form first current collector layer 16 on surface 10; (2) spraying first liquid electrode composition 20 from container 18 above first current collector layer 16 to form first electrode layer 22 on first current collector layer 16; (3) spraying liquid electrically insulating composition 26 from container 24 above first electrode layer 22 to form electrically insulating layer 28 on first electrode layer 22; (4) spraying second liquid electrode composition 32 from container 30 above electrically insulating layer 28 to form second electrode layer 34 on electrically insulating layer 28; and (5) spraying second liquid current collector composition 38 from container 36 on second electrode layer 34 to form second current collector layer 40 on second electrode layer 34.

The aforementioned methods can have various embodiments. For instance, in some embodiments, the first non-solid current collector composition is an anode current collector composition that forms an anode current collector layer, the first non-solid electrode composition is an anode electrode composition that forms an anode electrode layer, the second non-solid electrode composition is a cathode electrode composition that forms a cathode electrode layer, and the second non-solid current collector composition is a cathode current collector composition that forms a cathode current collector layer. In other embodiments, the first non-solid current collector composition is a cathode current collector composition that forms a cathode current collector layer, the first non-solid electrode composition is a cathode electrode composition that forms a cathode electrode layer, the second non-solid electrode composition is an anode electrode composition that forms an anode electrode layer, and the second non-solid current collector composition is an anode current collector composition that forms an anode current collector layer.

In further embodiments, the present disclosure provides methods of forming a multilayer energy storage device on a surface that serves as a first current collector layer. Such methods generally include: (1) applying a first non-solid electrode composition above the surface to form a first electrode layer above the surface; (2) applying a non-solid electrically insulating composition above the first electrode layer to form an electrically insulating layer above the first electrode layer; (3) applying a second non-solid electrode composition above the electrically insulating layer to form a second electrode layer above the electrically insulating layer; and (4) applying a second solid or non-solid current collector composition above the second electrode layer to form a second current collector layer above the second electrode layer. In some embodiments, the second current collector layer may also be derived from a solid current collector composition that is applied directly above the second electrode layer. In some embodiments, the second current collector layer may be derived from a non-solid current collector composition that is sprayed above the second electrode layer.

A more specific embodiment of the aforementioned methods is shown in FIG. 1B, where surface 50 also serves as a first current collector layer and the remaining layers are derived from liquid compositions. In this embodiment, multilayer energy storage device 82 is formed on surface 50 by: (1) spraying first liquid electrode composition 54 from container 52 above surface 50 to form a first electrode layer 56 on surface 50; (2) spraying liquid electrically insulating composition 60 from container 58 above first electrode layer 56 to form electrically insulating layer 62 on first electrode layer 56; (3) spraying second liquid electrode composition 66 from container 64 above electrically insulating layer 62 to form a second electrode layer 68 on electrically insulating layer 62; and (4) spraying second liquid current collector composition 72 from container 70 above second electrode layer 68 to form second current collector layer 74 on second electrode layer 68.

Another embodiment of the aforementioned method is shown in FIG. 1C, where surface 100 serves as a first current collector layer, the second current collector is derived from a solid composition, and the remaining layers are derived from liquid compositions. In this embodiment, multilayer energy storage device 132 is formed on surface 100 by: (1) spraying first liquid electrode composition 104 from container 102 above surface 100 to form first electrode layer 106 on surface 100; (2) spraying liquid electrically insulating composition 110 from container 108 above first electrode layer 106 to form electrically insulating layer 112 on first electrode layer 106; (3) spraying second liquid electrode composition 116 from container 114 above electrically insulating layer 112 to form second electrode layer 118 on electrically insulating layer 112; and (4) applying second solid current collector composition 124 above second electrode layer 118 to form second current collector layer 124 on second electrode layer 118.

The aforementioned methods can also have various embodiments. For instance, in some embodiments, the surface serves as an anode current collector layer, the first non-solid electrode composition is an anode electrode composition that forms an anode electrode layer, the second non-solid electrode composition is a cathode electrode composition that forms a cathode electrode layer, and the second solid or non-solid current collector composition is a cathode current collector composition that forms a cathode current collector layer. In additional embodiments, the surface serves as a cathode current collector layer, the first non-solid electrode composition is a cathode electrode composition that forms a cathode electrode layer, the second non-solid electrode composition is an anode electrode composition that forms an anode electrode layer, and the second solid or non-solid current collector composition is an anode current collector composition that forms an anode current collector layer.

As set forth in more detail herein, the methods of the present disclosure can be used to make multilayer energy storage devices that can more effectively assemble into various objects and spaces. For instance, the upper panel of FIG. 1D provides a depiction of a conventional multi-layer energy storage device 220 that is assembled within area 210 of energy device 200. The lower panel of FIG. 1D depicts multi-layer energy storage device 320, which was formed in accordance with the methods of the present disclosure in area 310 of energy device 300. As shown, multilayer energy storage device 320 more effectively utilizes area 310 of energy device 300 than conventional multi-layer energy storage device 220 utilizes area 210 of energy device 200.

As further illustrated herein, the methods of the present disclosure have numerous additional embodiments and variations. For instance, various forms of solid and non-solid compositions may be applied to various surfaces by various application methods to form various forms of multilayer energy storage devices.

### Compositions

The methods of the present disclosure can utilize various types of current collector compositions, electrode compositions, and electrically insulating compositions to form the individual layers of the multilayer energy storage devices. In some embodiments, the compositions of the present disclosure may be in solid form. In some embodiments, the compositions of the present disclosure may be in non-solid form before an application step, such as in liquid form. Thereafter, the compositions may form one or more solid layers that become part of a multilayer energy storage device.

In some embodiments, the non-solid compositions may be in liquid form, such as in the form of sols, gels, liquid emulsions, liquid dispersions, and combinations thereof. In some embodiments, the non-solid compositions may be in the form of an emulsion. In some embodiments, the non-solid compositions may be in the form of a sol (i.e., liquid dispersion). In some embodiments, the non-solid compositions may be in the form of gels. In some embodiments, the non-solid compositions may be in the form of paints.

Layer Formation

Various methods may be used to form individual layers from the compositions of the present disclosure. In some embodiments, layers may form by applying respective compositions above a surface or another layer. Various methods may be used for such application steps. Exemplary application methods may include, without limitation, spraying, painting, brushing, rolling, printing, thermal spraying, cold spraying and combinations of such methods. In some embodiments, the applying may occur by spraying respective compositions above a surface or another layer. In some embodiments, the spraying may include, without limitation, ultrasonic spraying, thermal spraying, electrostatic spraying, and combinations thereof.

In more specific embodiments, the applying may occur by spray painting techniques, such as spray painting compositions from aerosol cans, spray guns, or air brushes. In some embodiments, the applying of a layer may be followed by hot or cold roll pressing of the layer one or more times to achieve a higher degree of compaction. In some embodiments where a composition is in solid form (e.g., a second solid current collector layer 124 in FIG. 1C), the applying step may include placing the solid composition above another layer by various mechanical methods.

Furthermore, each layer of a formed multilayer energy storage device may be composed of a single layer or multiple sub-layers. For instance, in some embodiments, a composition can be applied above a surface or another layer multiple times to form a plurality of layers above the surface or the other layer. In other embodiments, a composition can be applied above a surface or another layer once to form a single layer above the surface or the other layer. In some embodiments, the compositions that are applied multiple times may be the same compositions. In some embodiments, the compositions that are applied multiple times may include one or more different compositions.

In more specific embodiments, a non-solid electrically insulating composition can be applied above a first electrode layer multiple times to form a plurality of electrically insulating layers above the first electrode layer. In further embodiments, one or more different non-solid electrically insulating compositions may be applied above the first electrode layer multiple times to form a plurality of one or more different non-solid electrically insulating layers above the first electrode layer. In some embodiments, a plurality of distinct non-solid electrically insulating compositions may be applied sequentially above the electrode layer to form a plurality of electrically insulating layers, each with a distinct composition. In other embodiments, the non-solid electrically insulating composition can be applied once to form a single electrically insulating layer above the first electrode layer.

Furthermore, the formed layers of the present disclosure can have various thicknesses. For instance, in some embodiments, a formed layer may have a thickness that ranges from about 0.1 μm to about 1 mm. In some embodiments, a formed layer may have a thickness that ranges from about 1 μm to about 500 μm. In some embodiments, a formed layer may have a thickness of about 200 μm.

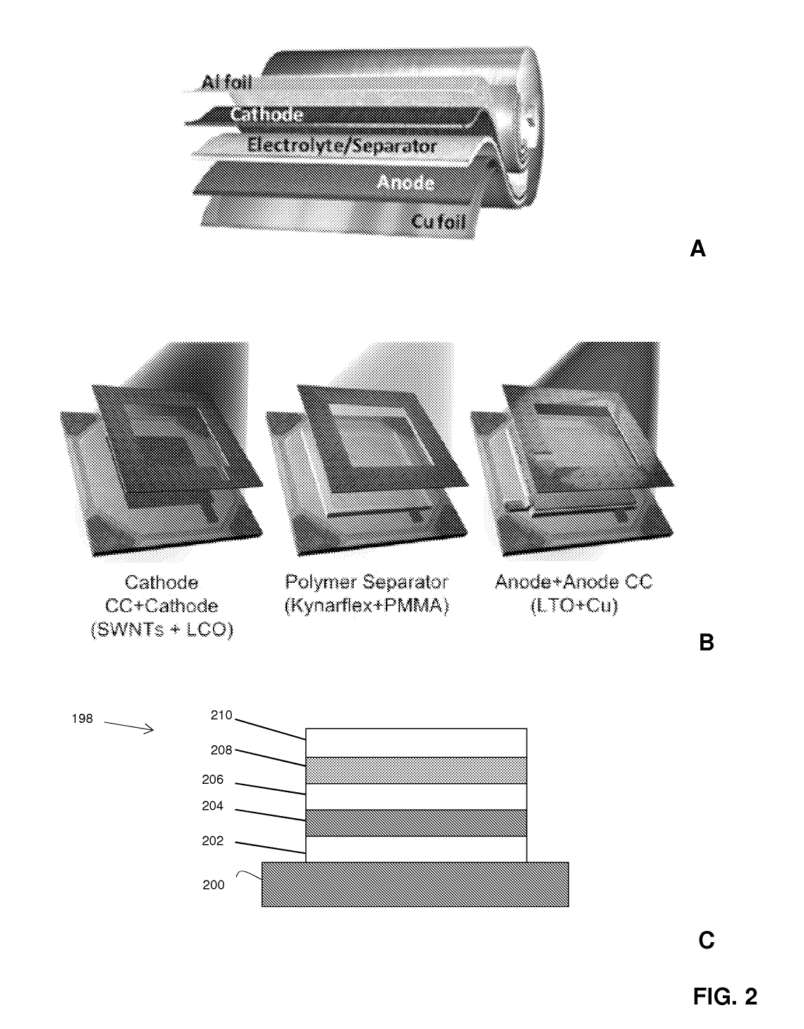

The formed layers may also have various shapes and sizes. In some embodiments, the layers may be in the form of circles, ovals, triangles, squares, rectangles, and other shapes. In some embodiments, the formed layers may have a pre-defined shape that is conferred by a mold or a cast. For instance, in some embodiments that are illustrated in FIG. 2B, layers with desired shapes may be achieved by using a stencil or shadow mask. In some embodiments, layers with desired shapes may be achieved by the use of precisely defined movements of a robotic device, such as a robotic manipulator or arm.

Furthermore, the layers of the present disclosure may be derived from various types of compositions. In particular, various current collector compositions, electrode compositions, and electrically insulating compositions may be utilized to form the individual layers.

Current Collector Compositions

Current collector compositions generally refer to compositions that form an electrically conducting current collector layer. In various embodiments, the current collector layers can be in contact with the respective electrode layers and capable of collecting current from the electrode layer, or supplying current to the electrode layer. In some embodiments, the current collector compositions of the present disclosure may be in solid form, such as in the form of a metallic or metallized surface (e.g., surface 50 or surface 100 in FIGS. 1B and 1C, respectively) or a solid composition (e.g., second solid current collector composition 124). In some embodiments, the current collector compositions of the present disclosure may be in non-solid form, as previously described (e.g., liquid dispersions and liquid emulsions).

In some embodiments, the current collector compositions of the present disclosure may be cathode current collector compositions that can collect current from or supply current to the positive electrode (also known as the cathode electrode). In some embodiments, the cathode current collector compositions may include, without limitation, aluminum, iron, gold, silver, carbon nanotubes, graphene, conducting polymers, and combinations thereof. In more specific embodiments, the cathode current collector compositions may include carbon nanotubes, such as single-walled carbon nanotubes (SWNTs), double-walled carbon nanotubes, multi-walled carbon nanotubes, ultra-short carbon nanotubes, functionalized carbon nanotubes, unfunctionalized carbon nanotubes, pristine carbon nanotubes, doped carbon nanotubes and combinations thereof.

In some embodiments, the current collector compositions of the present disclosure may be anode current collector compositions that can collect current from or supply current to the negative electrode (also known as the anode electrode). In some embodiments, the anode current collector composition may include, without limitation, copper, nickel, titanium, and combinations thereof.

In various embodiments, the current collector compositions of the present disclosure may also include additional materials. Such materials may include, without limitation, solvents, conductive nanomaterials, surfactants, and combinations thereof.

For instance, in some embodiments, the current collector compositions of the present disclosure may include, without limitation, one or more solvents, such as N-methylpyrrolidone (NMP), N,N-Dimethylformamaide (DMF), acetone, propanol, ethanol, methanol, water, and combinations thereof. Likewise, in some embodiments, the current collector compositions of the present disclosure may include one or more conductive nanomaterials, such as conductive nanoparticles, conductive micro particles, conductive nanowires, carbon nanotubes, carbon blacks, graphite (e.g., ultrafine graphite or UFG), carbon fibers, and combinations thereof. In some embodiments, the current collector compositions of the present disclosure may include one or more surfactants, such as sodium dodecyl sulfate (SDS), dodecylbenzenesulphonate (SDBS), dodecyltrimethylammonium bromide (DTAB), triton-x, and combinations thereof.

In more specific embodiments, the current collector compositions of the present disclosure may include a cathode current collector composition containing purified HiPCO SWNTs, carbon black (e.g., Super P™), and NMP. In further embodiments, the current collector compositions of the present disclosure may include an anode current collector composition containing copper conductive paint.

The current collector compositions of the present disclosure can be prepared by various methods. For instance, in some embodiments, current collector paints may be prepared by dispersing conductive powders (e.g., Cu or Ti powders for the anode current collector compositions and Cr or Al for the cathode current collector compositions) and nanomaterials (e.g. metallic nanoparticles or micro particles, metallic nanowires, single-walled or multi-walled carbon nanotubes) in water or organic solvents (e.g., DMF, ethanol, NMP, etc.) in the presence of surfactants (e.g., SDS, SDBS, triton, etc). More detailed aspects of such methods are disclosed in Example 1. Additional methods by which to make current collector compositions can also be envisioned.

In some embodiments, current collector compositions can be extended with conductive terminals. In some embodiments, the extensions can be done by attaching Al or Ni tabs, or by gluing.

Electrode Compositions

Electrode compositions generally refer to compositions that, when applied in the form of a layer, can serve as negative or positive electrodes (also known as anodes or cathodes) of an energy storage device. In some embodiments, the electrode compositions of the present disclosure may include a cathode electrode composition. In some embodiments, the cathode electrode composition may include, without limitation, lithium cobalt oxide (LiCoO₂), lithium manganese oxide (LiMn₂O₄), lithium iron phosphate (LiFePO₄), vanadium oxide (VO₂), lithium nickel manganese cobalt oxide (NMC), lithium nickel cobalt aluminum oxide (NCA), and combinations of thereof.

In some embodiments, the electrode compositions of the present disclosure may include an anode electrode composition. In some embodiments, the anode electrode composition may include, without limitation, at least one of graphite (e.g. natural or synthetic graphite), carbon materials, lithium titanium oxide (Li₄Ti₅O₁₂), silicon (Si), graphene, molybdenum sulfides, titanium oxide, tin (Sn), tin oxide, nitrides, and combinations thereof.

In various embodiments, the electrode compositions of the present disclosure may also include additional materials, including, but not limited to polymers, solvents, conductive nanomaterials, and combinations thereof. For instance, in some embodiments, the electrode compositions of the present disclosure may include one or more polymers, such as poly(vinylidene fluoride) (PVDF), poly(methy methacrylate) (PMMA), sodium carboxymethyl cellulose (CMC-Na), poly(tetrafluoroethylene) (PTFE), poly(vinyl acetate) (PVA), poly(vinylpyrrolidones) (PVP), polyacrylonitrile (PAN), polyethylene oxide (PEO), gelatin, Kynarflex™, polyimides, polyanilines, and combinations thereof.

Likewise, in some embodiments, the electrode compositions of the present disclosure may include, without limitation, one or more solvents, such as N-methylpyrrolidone (NMP), N,N-Dimethylformamaide (DMF), acetone, propanol, ethanol, methanol, water, and combinations thereof. In some embodiments, the electrode compositions of the present disclosure may include one or more conductive nanomaterials, such as conductive nanoparticles, conductive micro particles, conductive nanowires, carbon nanotubes, carbon blacks, graphite, carbon fibers, and combinations thereof.

In more specific embodiments, the electrode compositions of the present disclosure may include cathode electrode compositions containing LiCoO₂, carbon black (e.g., Super P™), UFG, and PVDF in NMP. In further embodiments, the electrode compositions of the present disclosure may include anode electrode compositions containing Li₄Ti₅O₁₂, UFG, and PVDF in NMP.

Furthermore, various methods may be utilized to make the electrode compositions of the present disclosure. Embodiments of such methods are disclosed in more detail in Example 1.

Electrically Insulating Compositions

Electrically insulating compositions generally refer to compositions that, when applied in the form of a layer, function as an electrically insulating barrier between the positive and negative electrodes of an energy storage device. In various embodiments, electrically insulating compositions can also function as an ion conducting medium between the positive and negative electrodes of an energy storage device. In the present disclosure, electrically insulating compositions may also be referred to as separators, polymer separators or electrolytes.

The electrically insulating compositions of the present disclosure may have various contents. In some embodiments, the electrically insulating compositions may include, without limitation, polymers, adhesion promoters, inorganic additives, solvents, electrolyte salts, electrolytes, solvents, and combinations thereof.

For instance, in some embodiments, the electrically insulating compositions of the present disclosure may include one or more polymers, such as poly(vinylidene fluoride) (PVDF), poly(methyl methacrylate) (PMMA), sodium carboxymethyl cellulose (CMC-Na), poly(tetrafluoroethylene) (PTFE), poly(vinyl acetate) (PVA), poly(vinylpyrrolidones) (PVP), poly(ethylene) (PE), polypropylene (PP), polyethylene oxide (PEO), gelatin, Kynar™ polyimides, and combinations thereof. Likewise, in some embodiments, the electrically insulating compositions of the present disclosure may include one or more adhesion promoters, such as acrylate polymers, epoxies, and combinations thereof.

In some embodiments, the electrically insulating compositions of the present disclosure may include one or more inorganic additives, such as inorganic oxides and inorganic nitrides. Suitable inorganic oxides may include, without limitation, magnesium oxides, titanium oxides, silicon oxides, aluminum oxides, and combinations thereof. Suitable inorganic nitrides may include, without limitation, boron nitrides, silicon nitrides, aluminum nitrides, magnesium nitrides, titanium nitrides, and combinations thereof.

In some embodiments, the electrically insulating compositions of the present disclosure may include one or more solvents. Suitable solvents, may include, without limitation, N-methylpyrrolidone (NMP), N,N-Dimethylformamaide (DMF), acetone, methyl ethyl ketone, hexane, chloroform, toluene, xylene, propanol, ethanol, methanol, water, and combinations thereof.

Likewise, in some embodiments, the electrically insulating compositions of the present disclosure may include one or more electrolytes. Suitable electrolytes may include, without limitation, LiPF₆, LiBF₄, LiClO₄, Li₇La₃Zr₂O₁₂, LiNO₃, lithium ion conducting room temperature ionic liquids, lithium ion conducting graphite oxide, and combinations thereof.

In more specific embodiments, the electrically insulating compositions of the present disclosure may include Kynarflex™, PMMA, SiO₂, acetone, and DMF. Additional electrically insulating compositions can also be envisioned.

Various methods may also be used to make the electrically insulating compositions of the present disclosure. In some embodiments, electrically insulating compositions can be made by dissolving a polymer or mixtures of polymers with one or more adhesion promoters and performance enhancing inorganic additives (e.g., 0-30 wt % or more) in one or more solvents. The one or more polymers used may include, without limitation, CMC-Na, Kynar-2801, PVDF, PTFE, PVA, PVP, Polyethylene, polypropylene, PEO, and combinations thereof. The adhesion promoters may include, without limitation, PMMA or other acrylate polymers. The performance enhancing inorganic additives and fillers used may include fumed SiO₂, Al₂O₃ or other inorganic oxides. The solvents used may include, without limitation, DMF, acetone, water, ethanol, methanol or combinations thereof.

In more specific embodiments, the electrically insulating compositions of the present disclosure may form by preparing a 9% w/v kynar-2801® (sol. A) and a PMMA (Sol. B) solution separately in acetone, preparing a 8% w/v dispersion of fumed SiO₂ in DMF, and mixing 6 parts of sol. A, 2 parts of sol. B and 1 part of sol. C to form the electrically insulating composition. Aspects of such methods are disclosed in more detail in Example 1. Additional methods by which to make electrically insulating compositions can also be envisioned.

Surfaces

The methods of the present disclosure may be applied above various surfaces in order to form multilayer energy storage devices on those surfaces. For instance, in some embodiments, the surfaces may include, without limitation, glasses, fabrics, metals, plastics, ceramics, and combinations thereof. In more specific embodiments, the surfaces may be glazed ceramics or flexible polymer substrates. In more specific embodiments, surfaces may include, without limitation, standard construction materials (e.g., ceramic tiles), common household objects (e.g., ceramic mug), stainless steel, and flexible polymer sheets. Other suitable surfaces may include, without limitation, vehicle components, aircraft components, walls, wearable electronics, clothes, plastic films, rigid plastics, flexible plastics, glazed ceramics, curved ceramics, wall papers, biocompatible polymers, and combinations thereof.

In some embodiments, the surface may be chemically cleaned before an application step. In some embodiments, such cleaning can help remove dirt, oil or other contaminants from the surface. In some embodiments, a surface can be pre-treated to increase adhesion of applied compositions (e.g., adhesion of painted layers with a substrate).

In some embodiments, the surface may be heated before or during an application step. For instance, in some embodiments, the surface may be heated from about 50° C. to about 200° C. before an application step. In some embodiments, the surface may be at room temperature during an application step.

In some embodiments, it may also be desirable for the surfaces to not have any potential for chemical reactions with the multilayer energy storage device components. In some embodiments, it may also be desirable for the surfaces to have good adhesive properties for the compositions that are applied to the surfaces.

Furthermore, the surfaces of the present disclosure may have various shapes and sizes. In some embodiments, the surfaces may be in the form of circles, ovals, triangles, squares, rectangles, and other shapes. In some embodiments, the surfaces may be flat. In some embodiments, the surfaces may be curved. In some embodiments, the surfaces may have a pre-defined shape that is conferred by a mold or a cast.

Formed Multilayer Energy Storage Devices

The methods of the present disclosure may be utilized to form various types of multilayer energy storage devices. In some embodiments, the formed multilayer energy storage devices may include, without limitation, capacitors, supercapacitors, batteries, hybrids thereof, and combinations thereof. In some embodiments, the formed multilayer energy storage devices may include batteries, such as lithium ion batteries. The formation of additional multilayer energy storage devices by the methods of the present disclosure can also be envisioned.

Variations and Post-Processing Steps

Additional embodiments of the present disclosure may also include a step of activating the formed multi-layer energy storage devices. For instance, in some embodiments, the activating may include an addition of an electrolyte to the formed multi-layer energy storage device. In some embodiments, the added electrolyte may include, without limitation, LiPF₆, LiBF₄, LiClO₄, LiNO₃, ethylene carbonate, di-methyl carbonate, propylene carbonate, water, lithium ion conducting room temperature ionic liquids, and combinations thereof. In some embodiments, the activated multilayer energy storage device may be sealed in a pouch (e.g., laminated aluminum foil or equivalent container) after electrolyte exposure. In some embodiments, the sealing may occur inside a glove box or other controlled environment.

Further embodiments of the present disclosure may also include a step of drying the formed multilayer energy storage devices. For instance, in some embodiments, the drying may occur in a vacuum. In some embodiments, the drying may occur in an oven or a heated environment. In some embodiments, the drying may occur by blow drying, such as blow drying with compressed air or with hot air.

In a more specific embodiment illustrated in FIG. 1C, the methods of the present disclosure were utilized to make integrated Lithium ion battery 198 on a 5×5 cm² substrate 200.

In this embodiment, each of the battery compositions were spray painted above substrate 200 in a layer-by-layer geometry. The compositions included SWNT-based positive current collector 202 (HIPCO SWNT and 20 wt % carbon black in NMP), LiCoO₂-based cathode material paint 204 (85 wt % LiCoO₂, 5 wt % carbon black, 3 wt % ultrafine graphite, and 7 wt % PVDF in NMP), polymeric separator paint 206, Li₄Ti₅O₁₂-based anode material paint 208 (80 wt % Li₄Ti₅O₁₂, 10 wt % ultrafine graphite, 10 wt % PVDF in NMP), and Cu-based current collector paint 210. Thereafter, the prepared paintable lithium ion battery 198 was packed in a laminated aluminum foil after the addition of 1M LiPF₆ in 1:1 (v/v) Ethylene Carbonate:Di-Methyl Carbonate electrolyte.

Applications and Advantages

The methods of the present disclosure provide numerous advantages and applications. In particular, the present disclosure provides a new and scalable approach to assemble multi-layer energy storage devices by utilizing simple and industrially viable application techniques, such as paint brushing or spray painting. As a result, the methods of the present disclosure reduce fabrication processing time by achieving fabrication of individual layers and their assembly simultaneously, thus reducing manufacturing steps over methods that involve separate processes for fabrication and assembly of individual layers. This is in turn can significantly reduce manufacturing costs.

Furthermore, since the layers can be formed by applying (e.g., spraying) liquid compositions sequentially, the physical interfaces between individual layers are generally more well-formed and intimate. The multilayer energy storage device thus formed may have reduced interfacial resistance at various interfaces. This in turn can reduce the equivalent series resistance (ESR) of the energy storage device, thereby enhancing device performance.

In addition, the methods of the present disclosure provide the ability to fabricate multi-layer energy storage devices in a scalable manner without any constraints on form, shape, flexibility, or volume. This in turn can allow for the direct integration of batteries and other multi-layer energy storage devices into various different objects and structures, including vehicles, aircraft, walls, wearable electronics, cloths, metals, glass, glazed ceramics, flexible polymer substrates, and the like. For the same reasons, the methods of the present disclosure can also allow for the facile integration of the formed multilayer energy storage devices with various energy harvesting devices (e.g., solar cells) to achieve standalone powering and storage devices.

### ADDITIONAL EMBODIMENTS

Reference will now be made to more specific embodiments of the present disclosure and experimental results that provide support for such embodiments. However, Applicants note that the disclosure herein is for illustrative purposes only and is not intended to limit the scope of the claimed subject matter in any way.

### Example 1

### Methods of Making Paintable Batteries

In this Example, Applicants demonstrate development of a scalable painting technique to fabricate fully functional Li-ion batteries on surfaces of virtually any materials and of any shape. In particular, Applicants have developed a fully paintable Li-ion battery that can be simultaneously fabricated and integrated with commonly encountered materials and objects of daily use. In this Example, Applicants adopted a spray-painting technique to assemble batteries (FIG. 2B) due to advantages such as ease of operation and flexibility in formulation from small-scale (aerosol cans) to industrial scale systems (spray guns).

Fabrication of batteries by spray painting requires formulation of component materials into liquid dispersions (paints), which can be sequentially coated on substrates to achieve the multilayer battery configuration. Commercial Li-ion batteries have positive and negative electrode materials coated on appropriate current collectors, sandwiching an ion conducting separator (FIG. 2A). Aluminum and copper foils are commonly used current collectors (CC) (positive and negative CC respectively), while electrode materials and separators are chosen based on desired voltage, current capacity, operating temperature and safety considerations. In this Example, Applicants chose Lithium Cobalt Oxide [LiCoO₂] (LCO, positive electrode) and Lithium Titanium Oxide [Li₄Ti₅O₁₂] (LTO, negative electrode), for which the effective cell voltage is ˜2.5V.

It is desirable for current collector compositions to be chosen such that they are electrochemically compatible and stable in the corrosive and electrochemically active environment inside an energy storage device. In this example, Applicants used commercially available Cu paint (Caswell Inc.) to form the anode current collector layer. Single-walled carbon nanotube (SWNT) current collectors have been used in batteries due to their high electrical conductivity and electrochemical stability at potentials above 1V vs. Li/Li⁺. Applicants found that high concentrations (˜0.5-1% w/v) of SWNTs can be readily dispersed without using surfactants or polymeric binders by bath ultrasonication in 1-methyl-2-pyrrolidone (NMP) to form viscous, highly consistent inks suitable for spray painting. Applicants found that a 20% w/w of Super P™ conductive carbon (SPC) additive lowers the sheet resistance of the spray-painted SWNT films (˜2 mg/cm²) up to 10 Ω/sq, sufficient for use as cathode current collectors.

LCO paint was made by adding a mixture of LCO, SPC and ultrafine graphite (UFG) into Polyvinylidine fluoride (PVDF) binder solution in NMP. LTO paint was made by adding a mixture of LTO and UFG into a Polyvinylidine fluoride (PVDF) binder solution in NMP

In Li-ion polymer batteries, well-controlled microporosity of polymer separators is desired for optimal electrolyte uptake and formation of a microporous gel electrolyte (MGE) with high ionic conductivity, which is necessary for complete capacity utilization and its retention upon cycling. Thus, obtaining the right morphology in a spray-painted separator was considered the most crucial step for realization of a paintable Li-ion battery.

Furthermore, adhesion of the separator to various substrates is desired for making the paintable battery mechanically robust. Applicants could obtain microporous separators with good adhesion characteristics from a paint prepared by blending Kynarflex®-2801 (Kynarflex) polymer with poly(methyl methacrylate) (PMMA) and fumed SiO₂ (3:1:0.4 w/w ratio) in a 8:1 v/v mixture of acetone and N,N-Dimethylformamide (DMF). Kynarflex was used due to its good solubility in low boiling solvents and electrochemical stability in a wide voltage window, while PMMA was used to promote adhesion to a variety of substrates.

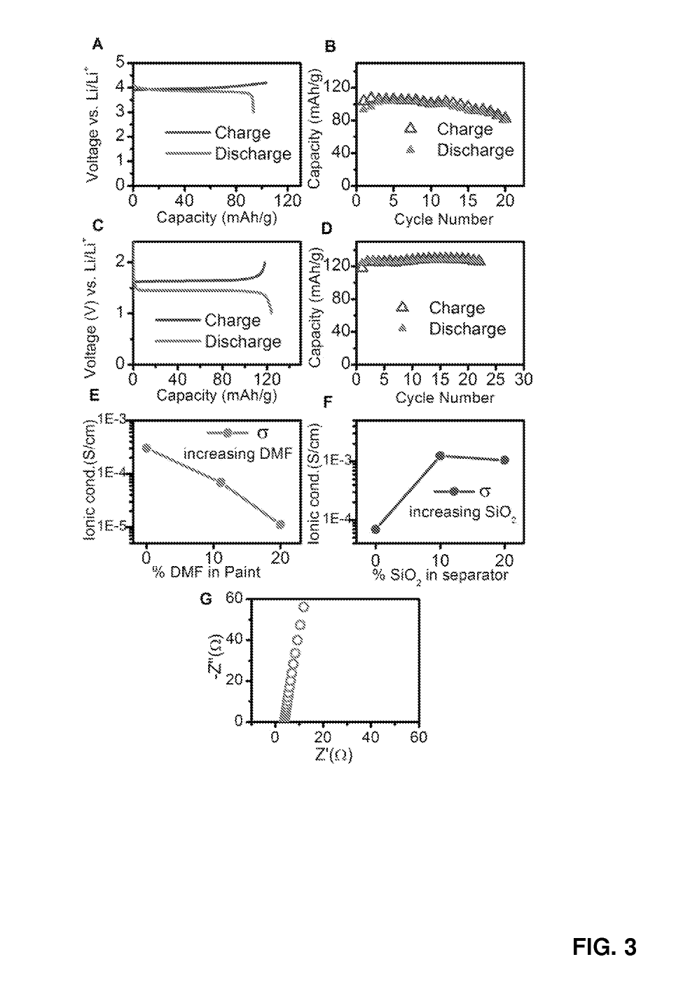

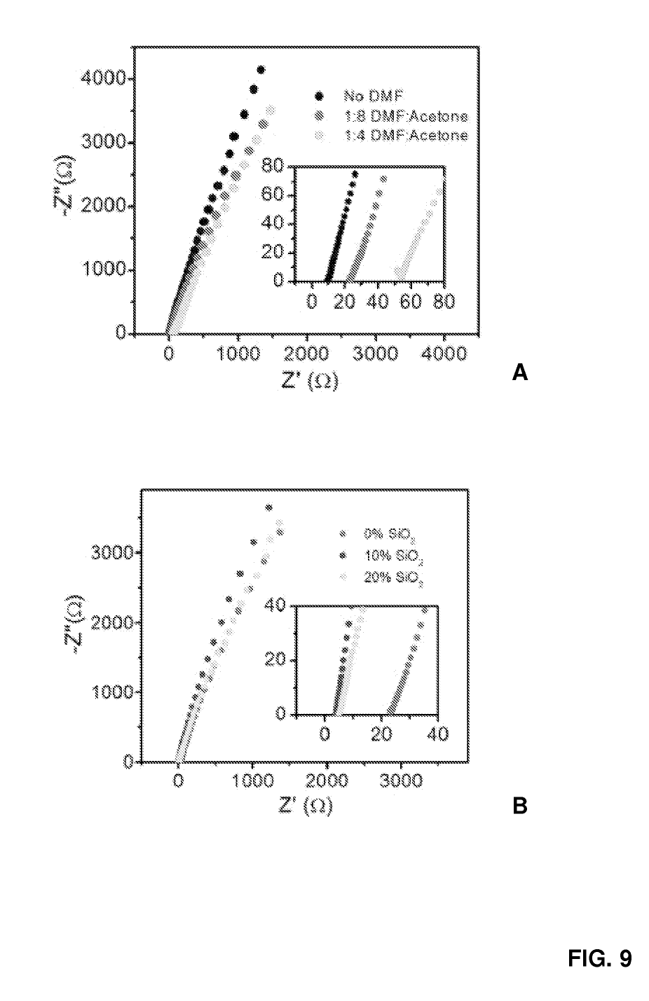

Kynarflex-PMMA separators fabricated from paints in acetone had good adhesion, but had high porosity and excessive electrolyte uptake. Such attributes made them mechanically unstable. However, Applicants found that, by adding DMF to the paint, the microporosity and electrolyte uptake could be tailored to make the separators mechanically robust upon electrolyte addition. This, however, also reduced the ionic conductivity of MGE by a factor of ˜4 at 11% DMF content (FIGS. 3E and 9A). A further addition of 10% w/w fumed SiO₂ to the separator helped offset this loss in conductivity and gave the best compromise between mechanical stability, porosity and ionic conductivity (FIGS. 3F-G) (details in experimental section below).

Spray painted LCO/Polymer and LTO/Polymer stacks were tested in half cell configuration to ensure that both electrodes were performing optimally with the optimized MGE. A Swagelok™ cell was used to electrochemically characterize the spray painted electrodes with polymer separator in the half cell configuration. LTO/Polymer/Li and LCO/Polymer/Li half-cells were cycled on Arbin Instruments BT-2000 battery cycler after soaking the polymer layer in the electrolyte for at least 2 h. LTO half-cells were cycled at a current rate of C/5 and LCO half-cells were cycled at C/8, where C is the current required to fully charge or discharge a cell in 1 h. Electrochemical characterization of fully spray painted Li-ion cells was done at current rate of C/8. Galvanostatic charge-discharge curves of both half-cells displayed expected plateau potentials (˜3.91V for LCO and ˜1.5V for LTO), good initial capacities (˜100 mAh/g for LCO, ˜125 mAh/g for LTO) and good capacity retention upon cycling (FIGS. 3A-D).

Li-ion cells were fabricated by spraying component paints with an airbrush onto desired substrates. Applicants started the assembly with the cathode CC, but the painting sequence can be easily reversed. Non-conducting substrates (glass, ceramics and polymer sheets) were preheated to 120° C. and the SWNT paint was sprayed onto them to deposit SWNT films (˜2 mg/cm², Rₛ˜10 Ω/sq). The LCO paint was then sprayed on top of the SWNT CC to deposit the LCO electrode (˜15 mg/cm² of LCO). After drying, the separator was deposited by spraying polymer paint onto the electrode preheated to 105° C. (˜T_{g} of PMMA). Then, the LTO paint was spray painted onto the separator preheated to ˜95° C. to deposit the LTO electrode (˜10 mg/cm²). Lastly, commercially available conductive Cu paint was sprayed onto the LTO electrode to serve as the anode CC. The cell was vacuum dried, transferred to an Argon filled glove box and after soaking in electrolyte, the finished cell was packaged with laminated aluminum foil (see experimental section below).

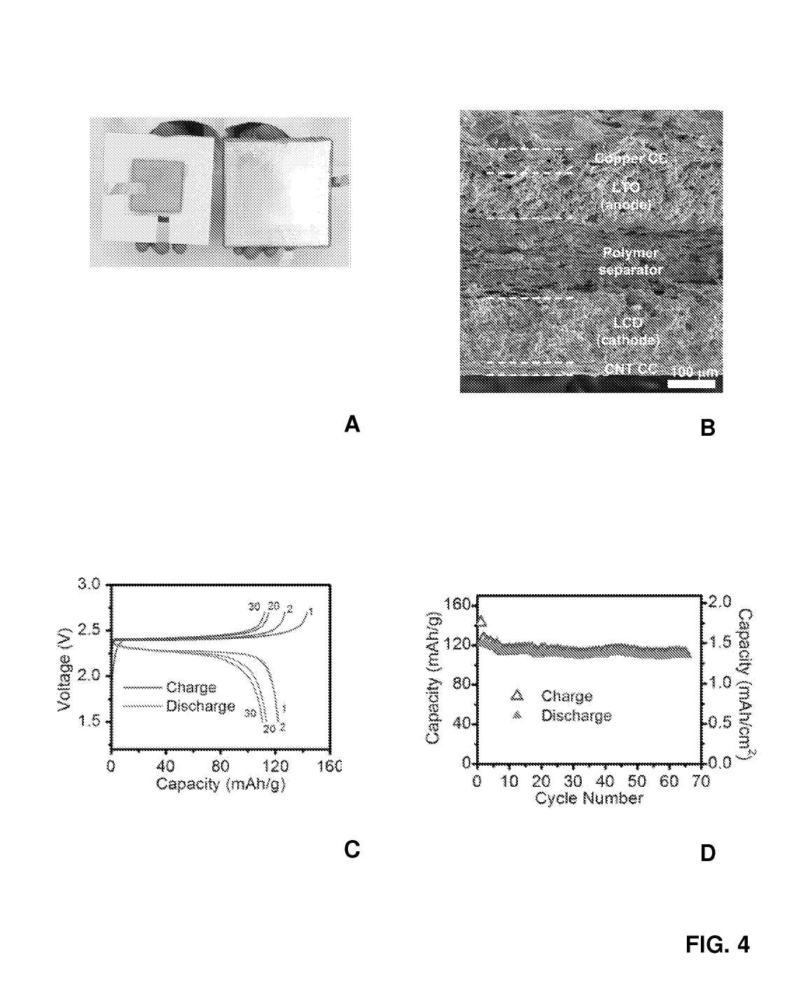

Cross-sectional SEM micrograph of a spray painted Li-ion cell (FIG. 4B) shows component layers with uniform thickness and well-formed interfaces. Galvanostatic charge-discharge curves of a similar Li-ion cell (FIG. 4C) showed plateau potentials (˜2.4V for charge and ˜2.3V for discharge) and discharge capacity (˜120 mAh per g of LTO) expected for the LTO-LCO electrode combination. The cell retained 90% of its capacity after 45 cycles with >98% columbic efficiency (FIG. 4D), suggesting that all components were working efficiently upon integration, without degradation or delamination of the cell stack.

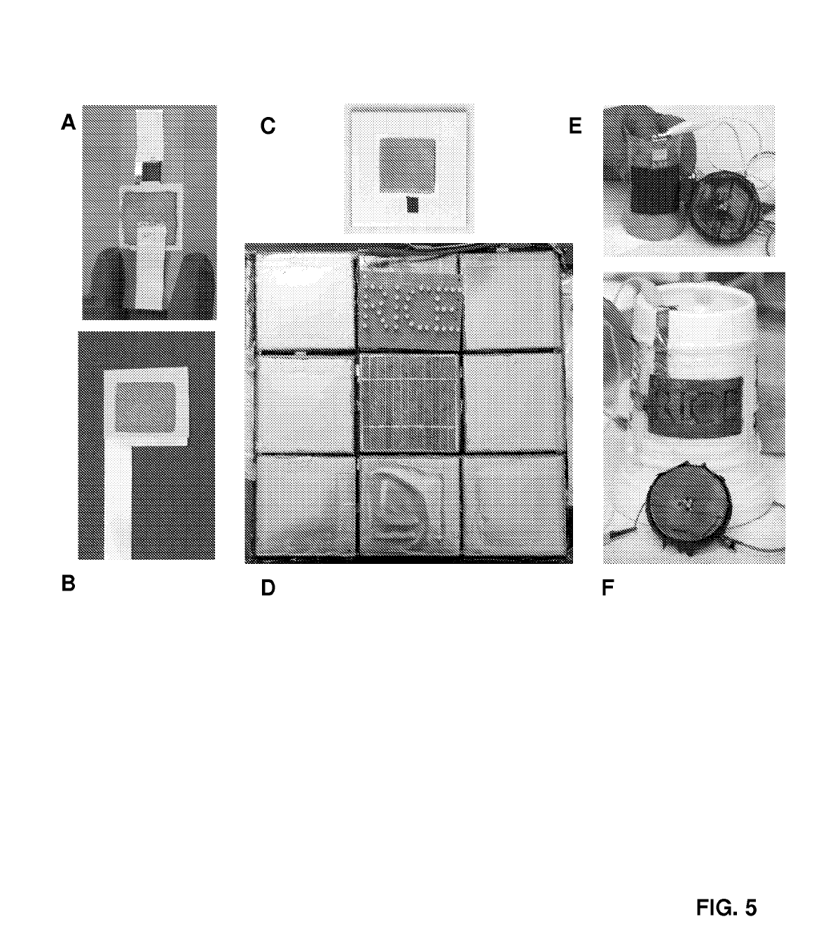

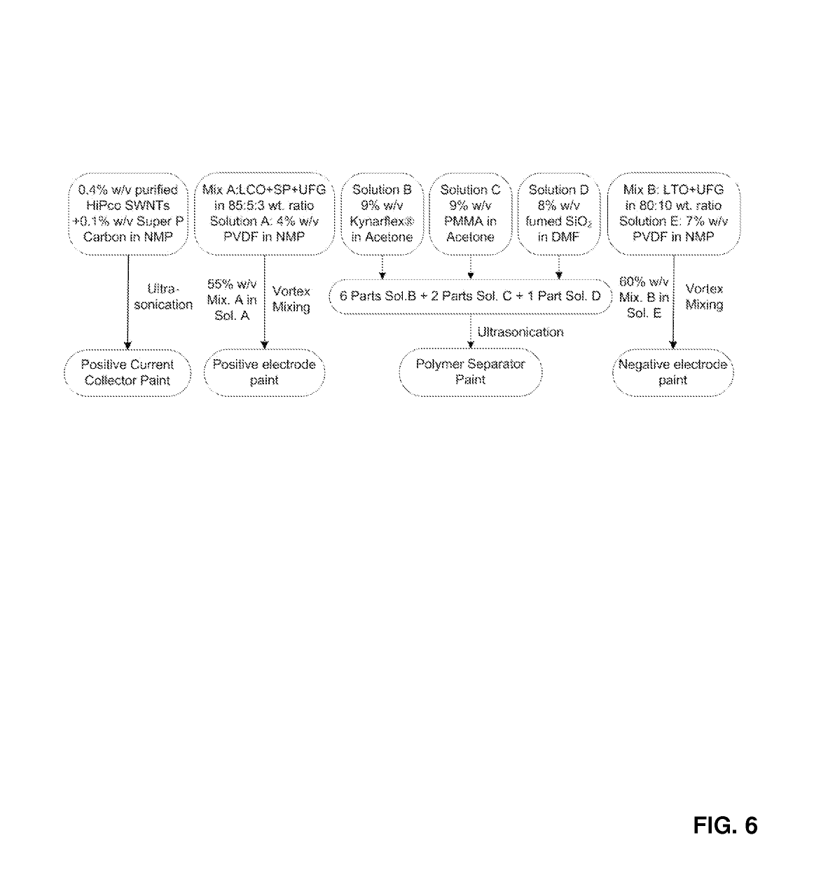

To demonstrate the versatility of spray painting, Applicants fabricated batteries on a wide variety of engineering materials, such as glass, stainless steel, glazed ceramic tiles and flexible polymer sheets without any surface conditioning (FIGS. 5A-C and 5E). Applicants observed no effect of substrate type on performance of batteries. Further, Applicants fabricated a battery conformally on the curved surface of a ceramic mug by spraying paints through a stencil mask spelling ‘RICE’ (FIG. 5E) to show the flexibility in surface forms and device geometries and footprints accessible using spray painting.

In summary, this Example demonstrates that battery materials can be engineered into paint formulations and simple spray painting techniques can be used to fabricate batteries directly on surfaces of various materials and of different shapes. The technique could be applied to virtually any multilayer energy storage devices such as capacitors or supercapacitors.

### Example 1.2

### Optimization of Polymer Separator

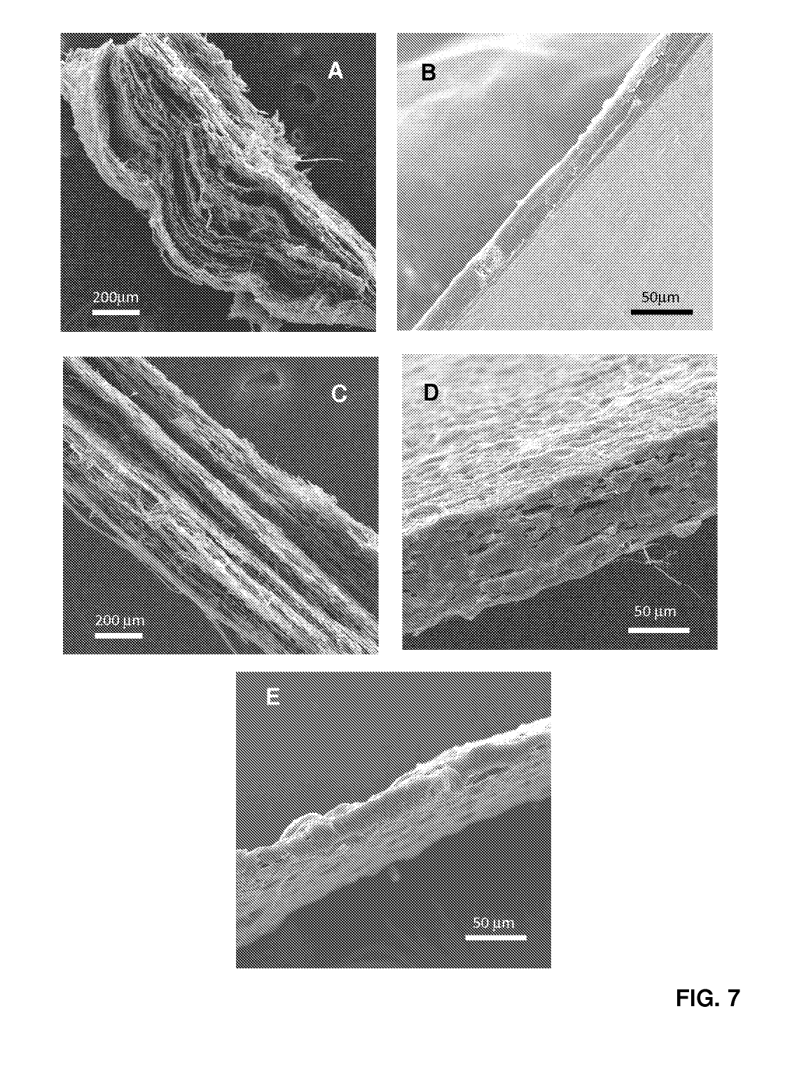

Kynarflex, a copolymer of PVDF and HFP, was chosen due to its good solubility in low-boiling solvents (such as acetone and THF) and its electrochemical stability in a wide potential window. Separators painted from Kynarflex paints in acetone were fibrous and highly porous (FIG. 7A), and became mechanically unstable upon addition of liquid electrolyte due to large volume change by swelling. On the other hand, those made using Kynarflex inks in DMF had virtually no porosity (FIG. 7B).

Mechanical robustness of the battery rests on good adhesion of the separator to substrates. Applicants found that 25% w/w of PMMA could be added to Kynarflex without compromising the mechanical properties of the separator. Separators made by using this PMMA:Kynarflex blend in acetone resulted in highly porous, well adhered separator films (FIG. 7C). However, their electrolyte uptake was still large and caused instantaneous detachment from the substrate. Thus controlling the porosity to tailor the electrolyte uptake was deemed necessary.

Separators made from Kynarflex/acetone paint were highly porous due to fast drying of polymer solution into fibrous strands during spraying (FIG. 7A), while Kynarflex/DMF inks dried slowly and resulted in non-porous films (FIG. 7B). Tailoring of porosity therefore, is tied to the solvents used. Since choice of solvents is limited, the porosity of the sprayed polymer separator was tailored by dissolving the Kynarflex/PMMA blend in a mixture of acetone and DMF in various ratios until the electrolyte uptake was sufficiently reduced to allow adhesion. It is evident from FIGS. 7C-E that increasing proportion of DMF reduces the porosity of the final sprayed polymer film but on the other hand, the films adhered well even on addition of electrolyte.

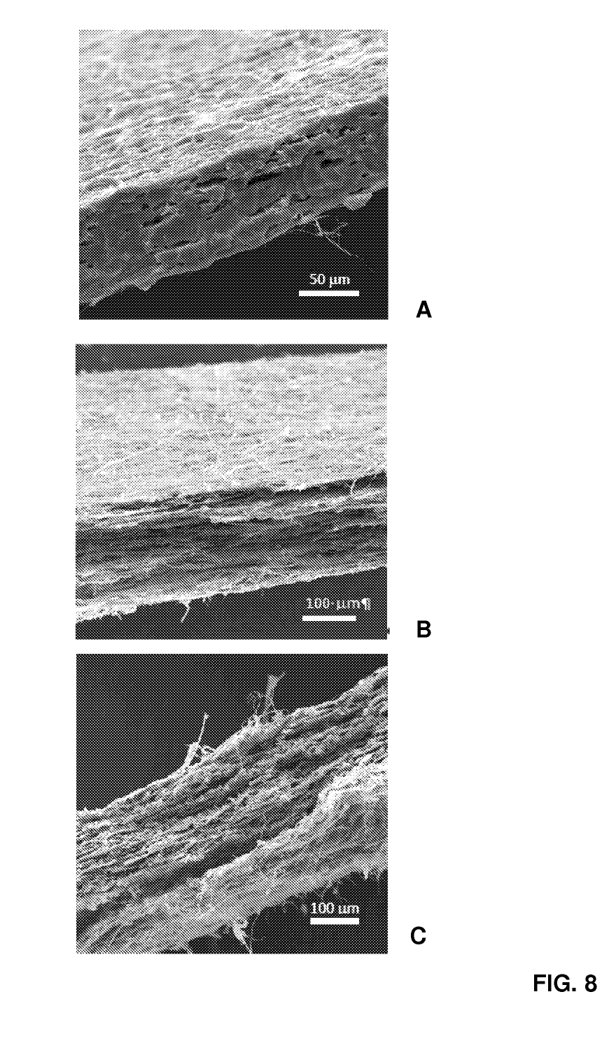

As a result, polymer separator films sprayed from 3:1 Kynarflex:PMMA in 1:8 DMF:Acetone were chosen for further studies. This reduced porosity, however, caused a four-fold increase in the electrolyte resistance (FIG. 3E). Inorganic oxide additives have been previously used to enhance electrolyte absorption by increasing porosity while increasing the mechanical stability of the microporous gel polymer electrolytes. Thus, varying percentages of fumed SiO₂ (Cabot Inc.) were added to the polymer separator paint. SEM micrographs show that the film containing no SiO₂ has the lowest porosity and addition of SiO₂ causes an increase in porosity (FIG. 8) and hence increases the ionic conductivity (FIG. 3F). The ionic conductivity at 10% w/w SiO₂ content was 1.24×10⁻³ S/cm, which is sufficiently high for Li-ion battery purposes.

Electrochemical Impedance Spectroscopy (EIS) of Polymer Separators

EIS characterization of painted polymer separators was done using AUTOLAB PGSTAT 302N. For EIS measurements, a polymer separator was sprayed onto a stainless steel (SS) foil and the measurement was performed in a Swagelok™ cell in SS/Kynarflex-PMMA/SS configuration over 100 KHz-1 Hz frequency range with a 10 mV AC bias. The SS worked as a blocking electrode. The microporous polymer separator was gelled with the electrolyte (LPF) consisting of 1M LiPF₆ solution in 1:1 (v/v) mixture of ethylene carbonate (EC) and dimethyl carbonate (DMC) and allowed to soak for at least for 2 h.

The impedance spectra of polymer films sprayed from paints containing different solvent ratios are shown in FIG. 9A. Paints with no DMF have very high ionic conductivity (obtained from the intercept of the spectrum with the real Z′ axis), while addition of DMF results in significant increase in electrolyte resistance (FIGS. 3E and 9A), in league with their porosity (FIG. 7). It is evident from impedance spectra that addition of SiO₂ reduces electrolyte resistance, and that 20% w/w of SiO₂ has no significant reduction as compared to 10% w/w content (FIGS. 8 and 9B).

### Example 1.4

### Fabrication of Tile Cells by Spray Painting

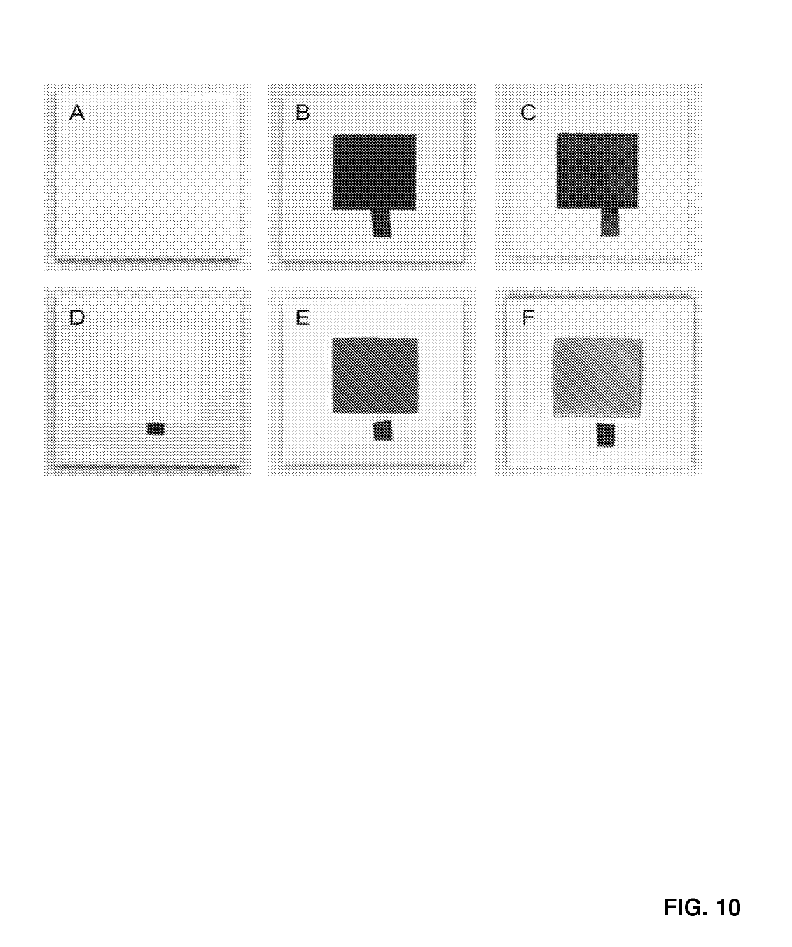

A spray painted Li-ion battery on glazed ceramic tile at various stages of fabrication is shown in FIG. 10. The cell area was 5×5 cm² and had a capacity of ˜30 mAh. Nine such cells were used in the demonstration described in the main text.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of forming a multilayer energy storage device on a surface, said method comprising:
applying a first liquid current collector composition above the surface to form a first current collector layer above the surface;
applying a first liquid electrode composition above the first current collector layer to form a first electrode layer above the first current collector layer;
applying a liquid electrically insulating composition above the first electrode layer to form an electrically insulating layer above the first electrode layer;
applying a second liquid electrode composition above the electrically insulating layer to form a second electrode layer above the electrically insulating layer; and
applying a second liquid current collector composition above the second electrode layer to form a second current collector layer above the second electrode layer.

2. The method of claim 1, wherein:
the first liquid current collector composition is an anode current collector composition that forms an anode current collector layer;
the first liquid electrode composition is an anode electrode composition that forms an anode electrode layer;
the second liquid electrode composition is a cathode electrode composition that forms a cathode electrode layer; and
the second liquid current collector composition is a cathode current collector composition that forms a cathode current collector layer.

3. The method of claim 1, wherein:
the first liquid current collector composition is a cathode current collector composition that forms a cathode current collector layer;
the first liquid electrode composition is a cathode electrode composition that forms a cathode electrode layer;
the second liquid electrode composition is an anode electrode composition that forms an anode electrode layer; and
the second liquid current collector composition is an anode current collector composition that forms an anode current collector layer.

4. The method of claim 1, wherein one of the first or second liquid current collector compositions is a cathode current collector composition.

5. The method of claim 4, wherein the cathode current collector composition comprises at least one of aluminum, iron, gold, silver, carbon nanotubes, graphene, conducting polymers, and combinations thereof.

6. The method of claim 4, wherein the cathode current collector composition comprises carbon nanotubes.

7. The method of claim 1, wherein one of the first or second liquid current collector compositions is an anode current collector composition.

8. The method of claim 7, wherein the anode current collector composition comprises at least one of copper, nickel, titanium, and combinations thereof.

9. The method of claim 1, wherein at least one of the first or second liquid current collector compositions comprises at least one of solvents, conductive nanomaterials, surfactants, and combinations thereof.

10. The method of claim 9, wherein the solvent is selected from the group consisting of N-methylpyrrolidone (NMP), N,N-Dimethylformamaide (DMF), acetone, propanol, ethanol, methanol, water, and combinations thereof.

11. The method of claim 9, wherein the conductive nanomaterial is selected from the group consisting of conductive nanoparticles, conductive micro particles, conductive nanowires, carbon nanotubes, carbon blacks, graphite, carbon fibers, and combinations thereof.

12. The method of claim 9, wherein the surfactants are selected from the group consisting of sodium dodecyl sulfate (SDS), dodecylbenzenesulphonate (SDBS), dodecyltrimethylammonium bromide (DTAB), triton-x, and combinations thereof.

13. The method of claim 1, wherein one of the first or second liquid electrode compositions comprises a cathode electrode composition.

14. The method of claim 13, wherein the cathode electrode composition comprises lithium cobalt oxide (LiCoO₂), lithium manganese oxide (LiMn₂O₄), lithium iron phosphate (LiFePO₄), vanadium oxide (VO₂), lithium nickel manganese cobalt oxide (NMC), lithium nickel cobalt aluminum oxide (NCA), and combinations of thereof.

15. The method of claim 1, wherein one of the first or second liquid electrode compositions comprises an anode electrode composition.

16. The method of claim 15, wherein the anode electrode composition comprises at least one of graphite, carbon materials, lithium titanium oxide (Li₄Ti₅O₁₂), silicon (Si), graphene, molybdenum sulfides, titanium oxide, tin (Sn), tin oxide, nitrides, and combinations thereof.

17. The method of claim 1, wherein at least one of the first or second liquid electrode compositions comprises at least one of polymers, solvents, conductive nanomaterials, and combinations thereof.

18. The method of claim 17, wherein the polymer is selected from the group consisting of poly(vinylidene fluoride) (PVDF), poly(methy methacrylate) (PMMA), sodium carboxymethyl cellulose (CMC-Na), poly(tetrafluoroethylene) (PTFE), poly(vinyl acetate) (PVA), poly(vinylpyrrolidones) (PVP), polyacrylonitrile (PAN), polyethylene oxide (PEO), gelatin, Kynarflex™, Polyimides, Polyanilines, and combinations thereof.

19. The method of claim 17, wherein the solvent is selected from the group consisting of N-methylpyrrolidone (NMP), N,N-Dimethylformamaide (DMF), acetone, propanol, ethanol, methanol, water, and combinations thereof.

20. The method of claim 17, wherein the conductive nanomaterial is selected from the group consisting of conductive nanoparticles, conductive micro particles, conductive nanowires, carbon nanotubes, carbon blacks, graphite, carbon fibers, and combinations thereof.

21. The method of claim 1, wherein the liquid electrically insulating composition comprises at least one of polymers, adhesives, adhesion promoters, inorganic additives, solvents, electrolyte salts, electrolyte solvents, and combinations thereof.

22. The method of claim 21, wherein the polymer is selected from the group consisting of poly(vinylidene fluoride) (PVDF), poly(methy methacrylate) (PMMA), sodium carboxymethyl cellulose (CMC-Na), poly(tetrafluoroethylene) (PTFE), poly(vinyl acetate) (PVA), poly(vinylpyrrolidones) (PVP), Poly(ethylene) (PE), polypropylene (PP), polyethylene oxide (PEO), gelatin, Kynar™, polyimides, and combinations thereof.

23. The method of claim 21, wherein the adhesion promoter is selected from the group consisting of acrylate polymers, silanes, epoxies, and combinations thereof.

24. The method of claim 21, wherein the inorganic additive comprises one or more inorganic oxides.

25. The method of claim 24, wherein the inorganic oxide is selected from the group consisting of magnesium oxides, titanium oxides, silicon oxides, aluminum oxides, and combinations thereof.

26. The method of claim 21, wherein the inorganic additive comprises one or more inorganic nitrides.

27. The method of claim 27, wherein the inorganic nitrides are selected from the group consisting of boron nitrides, silicon nitrides, aluminum nitrides, magnesium nitrides, titanium nitrides, and combinations thereof.

28. The method of claim 21, wherein the solvent is selected from the group consisting of N-methylpyrrolidone (NMP), N,N-Dimethylformamaide (DMF), acetone, methyl ethyl ketone, hexane, chloroform, toluene, xylene, propanol, ethanol, methanol, water, and combinations thereof.

29. The method of claim 21, wherein the electrolyte is selected from the group consisting of LiPF₆, LiBF₄, LiClO₄, Li₇La₃Zr₂O₁₂, LiNO₃, and combinations thereof.

30. The method of claim 1, wherein the liquid electrically insulating composition is applied above the first electrode layer multiple times to form a plurality of electrically insulating layers above the first electrode layer.

31. The method of claim 1, wherein the formed multilayer energy storage device is selected from the group consisting of capacitors, supercapacitors, batteries, hybrids thereof, and combinations thereof.

32. The method of claim 1, wherein the formed multilayer energy storage device is a lithium ion battery.

33. The method of claim 1, wherein the surface is selected from the group consisting of glass, fabrics, metals, plastics, ceramics, and combinations thereof.

34. The method of claim 1, wherein one or more of the applying steps are selected from the group consisting of spraying, brushing, rolling, printing, and combinations thereof.

35. The method of claim 1, wherein each of the applying steps comprises spraying.

36. The method of claim 1, further comprising a step of activating the formed multi-layer energy storage device.

37. The method of claim 36, wherein the activating comprises addition of an electrolyte to the formed multi-layer energy storage device.

38. The method of claim 37, wherein the electrolyte is selected from the group consisting of LiPF₆, LiBF₄, LiClO₄, Li₇La₃Zr₂O₁₂, LiNO₃, and combinations thereof.

39. The method of claim 1, further comprising a step of drying the formed multilayer energy storage device.

40. The method of claim 39, wherein the drying occurs in a vacuum.

41. The method of claim 1, wherein each of the liquid current collector compositions, liquid electrode compositions, and liquid electrically insulating composition is selected from the group consisting of sols, gels, liquid emulsions, liquid dispersions, and combinations thereof.

42. A method of forming a multilayer energy storage device on a surface, wherein the surface serves as a first current collector layer, said method comprising:
applying a first liquid electrode composition above the surface to form a first electrode layer above the surface;
applying a liquid electrically insulating composition above the first electrode layer to form an electrically insulating layer above the first electrode layer;
applying a second liquid electrode composition above the electrically insulating layer to form a second electrode layer above the electrically insulating layer; and
applying a second solid or liquid current collector composition above the second electrode layer to form a second current collector layer above the second electrode layer.

43. The method of claim 42, wherein:
the surface serves as an anode current collector layer;
the first liquid electrode composition is an anode electrode composition that forms an anode electrode layer;
the second liquid electrode composition is a cathode electrode composition that forms a cathode electrode layer; and
the second solid or liquid current collector composition is a cathode current collector composition that forms a cathode current collector layer.

44. The method of claim 42, wherein:
the surface serves as a cathode current collector layer;
the first liquid electrode composition is a cathode electrode composition that forms a cathode electrode layer;
the second liquid electrode composition is an anode electrode composition that forms an anode electrode layer; and
the second solid or liquid current collector composition is an anode current collector composition that forms an anode current collector layer.

45. The method of claim 42, wherein one of the surface or the second solid or liquid current collector composition is a cathode current collector composition.

46. The method of claim 45, wherein the cathode current collector composition comprises at least one of aluminum, iron, gold, silver, carbon nanotubes, graphene, conducting polymers, and combinations thereof.

47. The method of claim 42, wherein one of the surface or the second solid or liquid current collector composition is an anode current collector composition.

48. The method of claim 47, wherein the anode current collector composition comprises at least one of copper, nickel, titanium, and combinations thereof.

49. The method of claim 42, wherein one of the first or second liquid electrode compositions comprises a cathode electrode composition.

50. The method of claim 49, wherein the cathode electrode composition comprises lithium cobalt oxide (LiCoO₂), lithium manganese oxide (LiMn₂O₄), lithium iron phosphate (LiFePO₄), vanadium oxide (VO₂), lithium nickel manganese cobalt oxide (NMC), lithium nickel cobalt aluminum oxide (NCA), and combinations of thereof.

51. The method of claim 42, wherein one of the first or second liquid electrode compositions comprises an anode electrode composition.

52. The method of claim 51, wherein the anode electrode composition comprises at least one of graphite, carbon materials, lithium titanium oxide (Li₄Ti₅O₁₂), silicon (Si), graphene, molybdenum sulfides, titanium oxide, tin (Sn), tin oxide, nitrides, and combinations thereof.

53. The method of claim 42, wherein the liquid electrically insulating composition comprises at least one of polymers, adhesives, adhesion promoters, inorganic additives, solvents, electrolyte salts, electrolyte solvents, and combinations thereof.

54. The method of claim 53, wherein the liquid electrically insulating composition is applied above the first electrode layer multiple times to form a plurality of electrically insulating layers above the first electrode layer.

55. The method of claim 42, wherein the formed multilayer energy storage device is selected from the group consisting of capacitors, supercapacitors, batteries, hybrids thereof, and combinations thereof.

56. The method of claim 42, wherein the formed multilayer energy storage device is a lithium ion battery.

57. The method of claim 42, wherein the surface is a metal.

58. The method of claim 42, wherein the second solid or liquid current collector composition is a solid current collector composition.

59. The method of claim 58, wherein the solid current collector composition is a metal.

60. The method of claim 42, wherein one or more of the applying steps comprise at least one of spraying, brushing, rolling, printing, and combinations thereof.

61. The method of claim 42, further comprising a step of activating the formed multi-layer energy storage device.

62. The method of claim 61, wherein the activating comprises addition of an electrolyte to the formed multi-layer energy storage device.

63. The method of claim 42, wherein each of the second solid or liquid current collector composition, liquid electrode compositions, and liquid electrically insulating composition is selected from the group consisting of sols, gels, liquid emulsions, liquid dispersions, and combinations thereof.
